(19) United States
(12) Patent Application Publication
(10) Pub. No.: US 2006/0050893 A1
(43) Pub. Date: Mar. 9, 2006

(54) Headphone Antenna Assembly

(76) Inventor: Argy Petros, Lake Worth, FL (US)

Correspondence Address: THINK WIRELESS, INC., 6208 GRAND CYPRESS CIRCLE, LAKE WORTH, FL, 33463, US

(21) Appl. No.: 10/711,297

(22) Filed: Sep. 9, 2004

(51) Int. Cl. H04R 1/10; H04R 25/00

(52) U.S. Cl. 381/74; 381/384

(57) ABSTRACT

A headphone antenna assembly capable of efficiently receiving both satellite and terrestrial radio frequency signals in the Satellite Digital Audio Radio Service (SDARS) frequency band. Two embodiments are presented, one utilizing a patch antenna and the other utilizing a quadrifilar antenna.

### CROSS REFERENCE TO RELATED APPLICATIONS

(not applicable)

### BACKGROUND OF INVENTION

SDARS is a satellite broadcast service recently approved by the U.S. Federal Communications Commission (FCC) which provides satellite and terrestrial transmission of digital audio programs to compatible radio receivers. The SDARS frequency band is 2320 to 2345 MHz. The radio receivers can be stationary or mobile and are configured to receive signals from satellites as well as terrestrial repeaters.

Currently, most SDARS automotive antenna modules comprise patch antennas placed on vehicle roofs. As SDARS services are becoming more popular, there is a need of wearable SDARS devices. In this case, the receivers can be placed on the wearer's body in a similar fashion to MP3 players. Since wearable SDARS devices receive live signals, antenna placement is very critical. The best location for the antenna is on top of the wearer's head. This guarantees acceptable reception in all directions. Since headphones are also used in wearable SDARS receivers, it will be very beneficial if the antenna is part of the headphones or it is placed on top of the headphones.

One embodiment of the novel assembly is shown in FIG. 1. The patch antenna module is housed inside and on top of the headband. This antenna is capable of efficiently receiving both satellite and terrestrial signals in all directions. FIG. 2 shows the details of the cable assembly of the novel structure such as the headphone wires and audio connector and the antenna radio frequency cable and connector. FIG. 3 shows the details of the patch antenna module. FIG. 4 shows the wearable receiver and headphone antenna assembly. FIG. 5 shows an alternative embodiment where a short quadrifilar antenna is used.

### SUMMARY OF INVENTION

In a first aspect of the present invention, the headphone antenna assembly includes a patch antenna module placed inside the headband. The audio and radio frequency wires are bundled or molded together forming a single structure of three cables.

In a second aspect of the present invention, the patch antenna of the first embodiment is replaced by a short quadrifilar antenna.

In a third aspect of the present invention, the metallic rings are shaped into tubular form and inserted inside the tubular quadrifilar antenna.

### BRIEF DESCRIPTION OF DRAWINGS

FIG. 1 is a diagram showing the headphone antenna assembly of the first embodiment.

FIG. 2 shows the details of the cable assembly of the novel structure.

FIG. 3 shows the elements of the patch antenna module.

FIG. 4 shows the wearable receiver and headphone antenna assembly.

FIG. 5 shows an alternative embodiment of the assembly.

### DETAILED DESCRIPTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

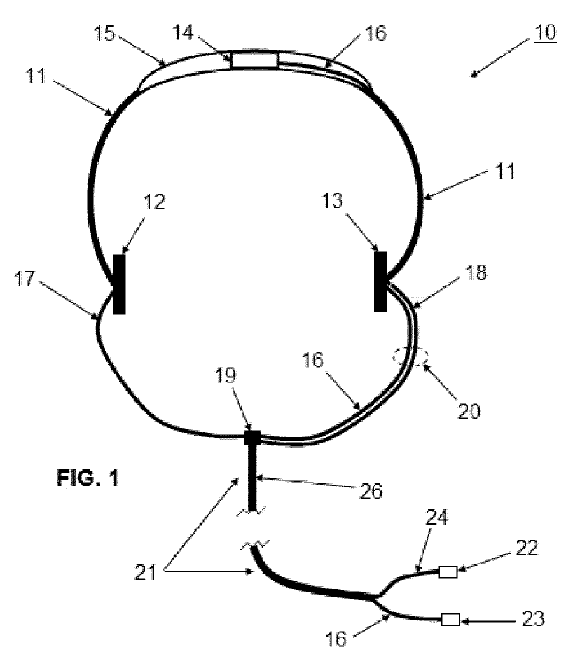

FIG. 1 shows the headphone antenna assembly 10. The headband 11 interconnects earpieces 12 and 13. The antenna module 14 is housed inside the top section 15 of headband 11. The top section of the antenna module radio frequency (RF) cable 16 is connected to antenna module 14 and it is housed inside headband 11. Audio cables 17 and 18 are connected to earpieces 12 and 13, respectively. Cable sub-assembly 20 comprises of audio cable 18 and part of the RF cable 16. Audio cables 17 and 18 and RF cable 16 are grouped together at point 19 and then forming cable assembly 21. In sub-assembly 26, the plastic jackets of audio cables 17, 18, and RF cable 16 are molded or joined together. The bottom ends of audio cables 17 and 18 are molded together forming audio cable assembly 24 and connected to audio connector 22 while the bottom end of RF cable 16 is connected to RF connector 23.

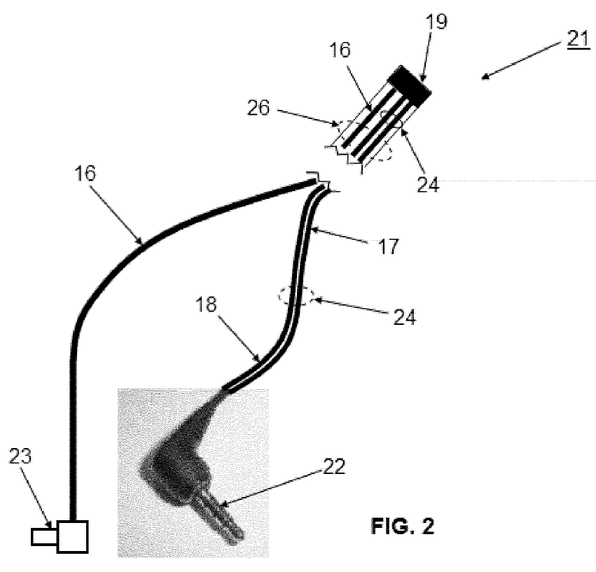

FIG. 2 shows the details of cable assembly 21 of the novel structure. Audio cables 17, 18 and RF cable 16 are grouped together at point 19. The plastic jackets of audio cables 17, 18, and RF cable 16 are molded or joined together forming sub-assembly 26. The length of sub-assembly 26 is approximately three feet. At the end of sub-assembly 26, the cables are split into two sub-assemblies: RF cable 16 and audio cable assembly 24. RF cable 16 is connected to RF connector 23, while audio cables 17 and 18 are connected to audio connector 22.

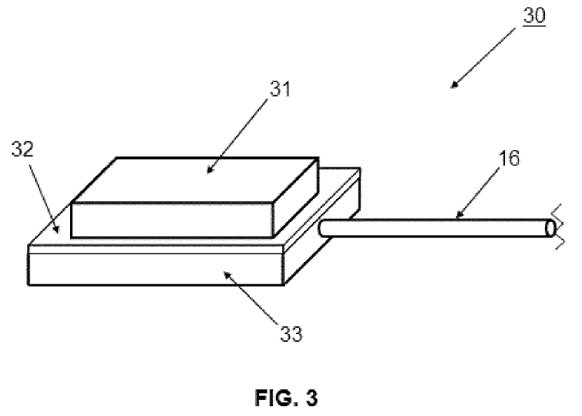

FIG. 3 shows the elements of the patch antenna module 30. Dielectric patch 31 is placed on top of the low noise amplifier (LNA) printed circuit board (PCB) 32 and it is connected to the LNA input. The LNA components are placed on the bottom side of PCB 32. A shield cover 33 is placed on top of the LNA parts. A typical size of the dielectric patch 31 is: (x, y, z)=(18 mm, 18 mm, 4 mm). RF cable 16 is connected to the LNA output. A typical size of the antenna module including the patch antenna, PCB, and LNA cover, is: (x, y, z)=(22 mm, 22 mm, 8 mm). This small structure can easily be housed inside the top section of the headband. The diameter of RF cable 16 is approximately 1.7 mm.

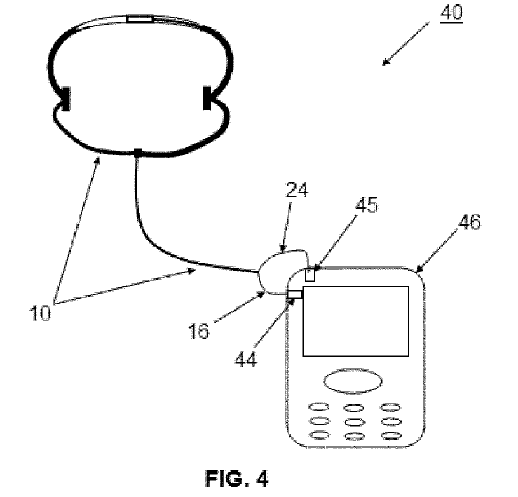

FIG. 4 shows the SDARS wearable receiver system 40 where the novel headphone antenna assembly 10 is connected to receiver 46. The audio connector at the end of audio cable assembly 24 is connected to the receiver's audio connector 45. The RF connector at the end of RF cable 16 is connected the receiver's RF connector 44.

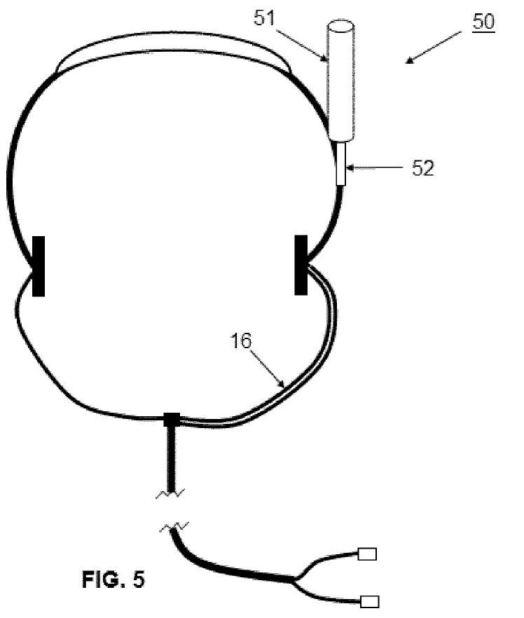

FIG. 5 shows an alternative embodiment of the novel headphone antenna assembly in accordance with the teachings of the present invention. Here, quadrifilar antenna 51 and LNA 52 are attached to the headband. The input of quadrifilar antenna 51 is connected to the input of LNA 52. RF cable 16 is connected to the output of LNA 52. The rest of the assembly is substantially identical to assembly 10 of FIG. 1.

What is claimed is:

1. An assembly, comprising:
two earpieces for receiving audio signals, said earpieces are adapted for positioning over the wearer's ears;
an antenna module comprising a ceramic patch antenna, and a low noise amplifier circuit, said antenna module being designed to operate in the frequency band of 2320 to 2345 MHz, said patch antenna being connected to the said low noise amplifier input;
a headband structure housing the said antenna module and interconnecting said earpieces, said headband and said antenna module together form a single piece integrally formed structure;
a cable assembly comprising two audio cables, an audio connector, a radio frequency cable, and a radio frequency connector, one end of each said audio cable being connected to each said earpiece, the other end of each said audio cable being connected to the said audio connector, one end of the said radio frequency cable is connected to the said patch antenna module, the other end of said radio frequency cable is connected to the said radio frequency connector.

2. The assembly of claim 1 where the said antenna module is attached to the top of the headband through mounting means.

3. An assembly, comprising:
two earpieces for receiving audio signals, said earpieces are adapted for positioning over the wearer's ears;
an antenna module comprising a quadrifilar antenna and a low noise amplifier circuit, said antenna module is designed to operate in the frequency band of 2320 to 2345 MHz, said quadrifilar antenna being connected to the said low noise amplifier input;
a headband structure interconnecting said earpieces, said headband and said antenna module together form a single piece integrally formed structure;
a cable assembly comprising two audio cables, an audio connector, a radio frequency cable, and a radio frequency connector, one end of each said audio cable being connected to each said earpiece, the other end of each said audio cable being connected to the said audio connector, one end of the said radio frequency cable is connected to the said quadrifilar antenna module, the other end of said radio frequency cable is connected to the said radio frequency connector.

4. The assembly of claim 3 where the antenna module is attached to the headband through mounting means.
